(19) United States
(12) Patent Application Publication
(10) Pub. No.: US 2024/0281850 A1
(43) Pub. Date: Aug. 22, 2024

(54) Mobile Advertising Vehicle-Mounted Billboard System and Method of Advertising

(71) Applicant: Dwayne Reed, Davisburg, MI (US)

(72) Inventor: Dwayne Reed, Davisburg, MI (US)

(21) Appl. No.: 18/584,617

(22) Filed: Feb. 22, 2024

Related U.S. Application Data
(60) Provisional application No. 63/447,410, filed on Feb. 22, 2023.

(51) Int. Cl. G06Q 30/0251; B60Q 1/50; B60R 16/033; G09F 9/33; G09F 21/04

(52) U.S. Cl. CPC G06Q 30/0265; B60Q 1/5035; B60R 16/033; G09F 9/33; G09F 21/048

(57) ABSTRACT

The present invention relates to a mobile billboard system. The system includes a digital billboard adapted to be installed on the exterior surface of a vehicle. The billboard can display text or image-based ads in multiple formats, is weatherproof, impact resistant, and utilizes LED technology for clear visibility in diverse lighting conditions. A microcomputer is installed in the vehicle for allowing users to input and configure advertisements. The microcomputer includes a user-friendly touch display, a keyboard, and a voice command functionality for hands-free operation. In some embodiments, the system can tag advertisements with GPS locations and geofences and define conditions such as time for displaying advertisements. The mobile advertising system, combining digital billboard technology with advanced microcomputer control, offers an innovative solution for dynamic, location-based advertising on moving vehicles.

### CROSS-REFERENCE TO RELATED APPLICATION

The present application claims priority to, and the benefit of, U.S. Provisional Application No. 63/447,410, which was filed on Feb. 22, 2023 and is incorporated herein by reference in its entirety.

### FIELD OF THE INVENTION

The present invention generally relates to the field of advertising billboard systems. More specifically, the present invention relates to a novel a unique, mobile billboard system designed to display an advertisement on a moving vehicle. The system includes a microcomputer installed inside a vehicle and can be controlled via touch screen, keyboard, or voice command for configuring advertisements to display on the billboard. Users can input an advertisement into the microcomputer and the advertisement is displayed on the billboard. The billboards can be installed on any vehicle such as a van, tractor trailer, or other commercial or private vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, billboards are commonly placed along roadways and are aimed at capturing the attention of motorists by displaying various messages or advertisements typically consisting of a combination of text and graphics. The primary purpose of billboards is advertising, leveraging high-traffic areas for maximum visibility. However, conventional billboards are stationary and unchanging, limiting their reach to only those who pass by the specific location. Further, using conventional billboards for advertising is expensive. Also, due to the static nature and fixed locations of billboards, many billboards may not achieve optimal visibility, leading to inadequate returns on investment (ROI). Conventional billboards are also ineffective in broadcasting information about emergency situations. People desire improved billboards that can increase the reach for effective marketing.

Currently, vehicle owners commonly use stickers for various purposes, including religious messages, group affiliations, or advertising. However, conventional stickers are typically vinyl-based and static, offering no flexibility in changing the message. Further, such static forms of vehicle advertising are not suitable for dynamic messaging needs, like broadcasting emergency information, ride sharing information, or traffic accidents. People desire dynamic advertising systems and methods including billboards that can be installed on the vehicles, offering greater flexibility and reach.

Therefore, there exists a long felt need in the art for mobile billboards adapted to be installed on vehicles for advertising. Additionally, there is a long felt need in the art for an improved billboard-based advertising system that improves reachability and ROI of the billboards. Moreover, there is a long felt need in the art for billboards that can be attached to the outer surfaces of vehicles, allowing for mobile advertising. Further, there is a long felt need in the art for a mobile advertising system that can display advertisements on billboards which are installed on the outer surface of the vehicles. Furthermore, there is a long felt need in the art for a mobile advertising system that improves ROI and cost-effectiveness of use of billboards. Also, there is a long felt need in the art for a dynamic advertising system that can be adapted to display different advertisements, identifying information, and messages using microcomputers installed inside the vehicles. Finally, there is a long felt need in the art for mobile billboards that offer a way for businesses to advertise in a mobile manner rather than purchasing stationary billboards on the side of a road.

The subject matter disclosed and claimed herein, in one embodiment thereof, comprises a mobile billboard advertising system for displaying advertisements on billboards installed on exterior surfaces of vehicles. The system comprises at least one digital billboard installed on the exterior surface of a vehicle. A microcomputer is located inside the vehicle and is configured to create, process, and manage the display of one or more advertisements on the digital billboard. An internal connector is adapted to connect the microcomputer to the digital billboard for transferring digital advertisement and providing electrical power to the billboard. The billboard uses a display technology such as LED display technology to provide clear and vibrant display of images and videos, maintaining high visibility even under bright daylight conditions. One or more conditions including time, location, and text can be configured using the microcomputer for a dynamic display of the advertisement.

In this manner, the mobile billboard advertising system of the present invention accomplishes all of the forgoing objectives and provides users with a mobile billboard installed on the exterior surface of a vehicle for displaying advertisement. With installation on a vehicle, the billboard can reach a broader audience by travelling through different locations. The mobile billboard can display changing content, making it suitable for a wide range of messages, including time-sensitive information or advertisements. The system eliminates use of static billboards and increases ROI on advertisements. The system provides dynamic advertising method that can move with the vehicle, offering greater flexibility and reach.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobile billboard system for displaying advertisements on an exterior surface of vehicles. The system comprises a digital billboard installed on the exterior surface of a vehicle. A microcomputer is located inside the vehicle and is configured to create, process, and manage the display of one or more advertisements on the digital billboard. An internal connector is adapted to connect the microcomputer to the digital billboard for transferring digital advertisement and providing electrical power to the billboard.

In another aspect, the power supply for the billboard is derived from one of the internal electrical supplies of vehicle or from an alternative power source including solar power or external power sources such as cells and batteries.

In yet another embodiment, an electronic billboard adapted to be positioned on an exterior surface of a vehicle is disclosed. The billboard is designed to display advertisements, wherein the advertisements can be presented in various formats including text, images, rolling, continuous, flashing, or any other format suitable for the advertiser's needs. The billboard uses LED display technology to provide clear and vibrant display of images and videos, maintaining high visibility even under bright daylight conditions.

In a further embodiment of the present invention, the microcomputer for configuring and controlling advertisements on the mobile electronic billboard is installed on the dashboard of the vehicle. The microcomputer includes a touch display for providing an interface for the input, editing, and manipulation of advertisements, and for the preview of configured advertisements. A keyboard for providing an alternate means for inputting advertisement. A microphone is included in the microcomputer, facilitating hands-free operation through voice command input. A set of controls are included within the microcomputer, enabling users to modify various aspects of the advertisement, such as font, colors, and overall appearance. A ticker display is included within the microcomputer for creating and displaying linear, horizontally, or vertically scrolling text advertisements.

In another example, a method for displaying advertisements on a mobile billboard installed on the side of a vehicle is described. The method includes the steps of inputting or configuring one or more advertisements into a microcomputer, wherein the microcomputer is installed inside the vehicle and is connected to the billboard. Tagging each advertisement with a GPS location and a geofence, enabling to display the advertisement only within a specified geofence, thereby facilitating targeted and personalized marketing and branding outreach. Detecting the real-time location of the vehicle equipped with the mobile billboard using the microcomputer. Displaying the advertisements on the billboard in real-time, wherein the advertisements are specifically those tagged with a geofence corresponding to the current location of the vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a functional block diagram of the mobile billboard system of the present invention in accordance with the disclosed structure;

FIG. 2 illustrates a perspective view showing the electronic billboard installed on a tractor's trailer in accordance with one embodiment of the present invention;

FIG. 3 illustrates a perspective view of the microcomputer used in the mobile billboard system of the present invention in accordance with the disclosed structure;

FIG. 4 illustrates a functional block diagram showing another embodiment of the mobile advertising system of the present invention with a central advertisement server for pushing advertisements in accordance with the disclosed architecture;

FIG. 5 illustrates flow diagram depicting a process of displaying advertisements on the electronic billboard of the mobile advertising system of the present invention in accordance with one embodiment;

FIG. 6 illustrates another flow diagram depicting display of customized advertisements based on the location of the vehicle in accordance with the disclosed architecture; and

FIG. 7 illustrates another embodiment of the electronic billboard of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for mobile billboards adapted to be installed on vehicles for advertising. Additionally, there is a long felt need in the art for an improved billboard-based advertising system that improves reachability and ROI of the billboards. Moreover, there is a long felt need in the art for billboards that can be attached to the outer surfaces of vehicles, allowing for mobile advertising. Further, there is a long felt need in the art for a mobile advertising system that can display advertisements on billboards which are installed on the outer surface of the vehicles. Furthermore, there is a long felt need in the art for a mobile advertising system that improves ROI and cost-effectiveness of use of billboards. Also, there is a long felt need in the art for a dynamic advertising system that can be adapted to display different advertisements and messages using microcomputers installed inside the vehicles. Finally, there is a long felt need in the art for mobile billboards that offer a way for businesses to advertise in a mobile manner rather than purchasing stationary billboards on the side of a road.

The present invention, in one exemplary embodiment, is a method for displaying advertisements on a mobile billboard installed on the side of a vehicle. The method includes the steps of inputting or configuring one or more advertisements into a microcomputer, wherein the microcomputer is installed inside the vehicle and is connected to the billboard. Tagging each advertisement with a GPS location and a geofence, enabling display of the advertisement only within a specified geofence, thereby facilitating targeted and personalized marketing and branding outreach. Detecting the real-time location of the vehicle equipped with the mobile billboard using the microcomputer. Displaying the advertisements on the billboard in real-time, wherein the advertisements are specifically those tagged with a geofence corresponding to the current location of the vehicle.

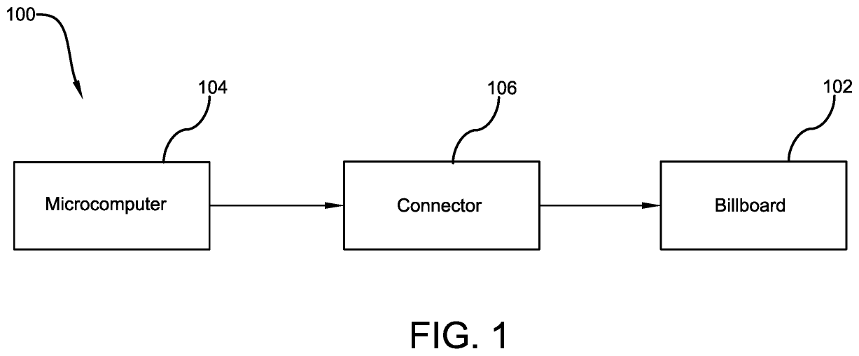

Referring initially to the drawings, FIG. 1 illustrates a functional block diagram of the mobile billboard system of the present invention in accordance with the disclosed structure. The mobile billboard system 100 of the present invention is designed as an advertising system for displaying advertisements on exterior surfaces of vehicles and can be integrated or used as an aftermarket product in a vehicle for advertising. More specifically, the mobile billboard system 100 includes a digital billboard 102 installed on the exterior surface of a vehicle. The billboard 102 is adapted to display selectable digital advertisements of different businesses for marketing and branding purposes. The billboard 102 can be powered using the internal electrical supply of the vehicle or can also be solar powered. In some embodiments, the billboard 102 can have external power supply in the form of cells and batteries.

For configuring custom advertisements for the billboard 102, a microcomputer 104 is installed in the vehicle and more preferably, on the dashboard of the vehicle. The microcomputer 104 includes a processor (i.e., processing power) for creating and processing one or more advertisements and is connected to the billboard 102 using an internal connector 106. The connector 106 can be in the form of an Electronic Control Unit (ECU) and can also be used for providing electric power to the mobile billboard 102. The microcomputer 104 and the billboard 102 can be integrated into a vehicle during manufacturing of the vehicle and can also be installed in existing vehicles.

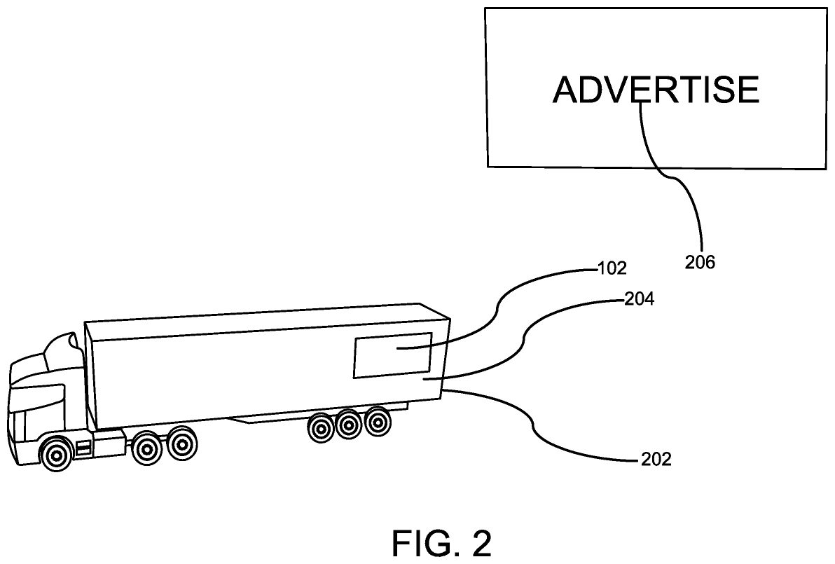

FIG. 2 illustrates a perspective view showing the electronic billboard installed on a tractor trailer in accordance with one embodiment of the present invention. In the present embodiment, the mobile electronic billboard 102 is installed on side surface 204 of the tractor's trailer 202. The billboard 102 displays the advertisement 206 which can be in the form of text or images and can be rolling, continuous, flashing or in any other appropriate format to meet the requirements of the advertiser.

The billboard 102 is weatherproof, durable and impact resistant. Further, the billboard 102 can use LED display technology for clear, vibrant image and video display, even in bright daylight. Further, the billboard 102 may adapt to different ambient light conditions to provide an effective display of advertisement 206. The billboard 102 is designed to prevent driver distraction and complies with traffic and advertising regulations. The billboard 102 can come in different sizes and shapes to conform to the exterior surface of different vehicles.

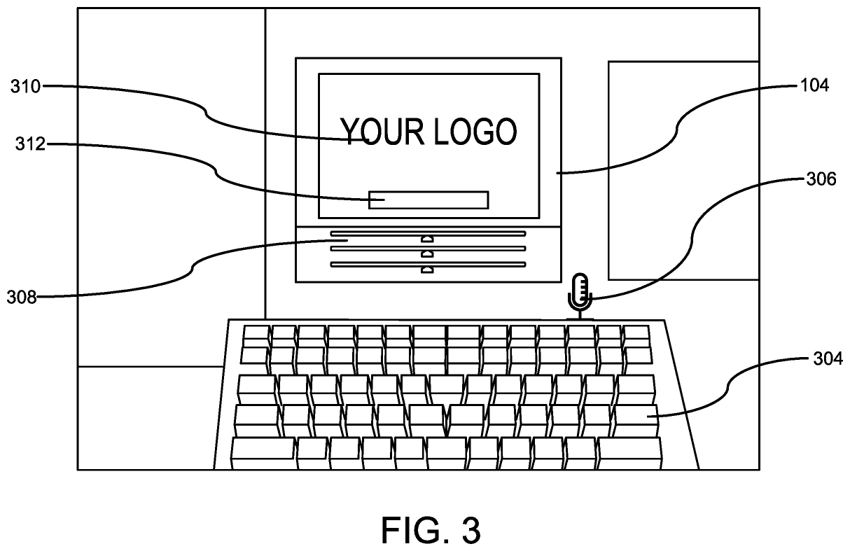

FIG. 3 illustrates a perspective view of the microcomputer used in the vehicle mounted billboard system of the present invention in accordance with the disclosed structure. The microcomputer 104 is adapted to configure different advertisements for the billboard 102. More specifically, the microcomputer 104 is installed inside the vehicle and can be used by driver or any passenger of the vehicle. In some embodiments, an authentication is required for accessing the microcomputer 104 and can be in the form of biometric authentication.

The microcomputer 104 includes a touch display 302 that provides a user-friendly interface for easy input and manipulation of advertisements. The touch display 302 also displays the advertisements configured using the microcomputer 104. A keyboard 304 is provided for providing a traditional means for input to create and manipulate advertisements. For providing hands-free operation, a microphone 306 is also included in the microcomputer 104 for allowing users to input using voice commands.

The microcomputer 104 provides a plurality of controls 308 for modifying font, colors, and appearance of the advertisement 310. The microcomputer 104 is used for displaying one or more identifiers or advertisements on the billboard 102, thereby providing easy control and operation of the vehicle mounted billboard system 100. A ticker display 312 is also included for displaying linear and horizontal scrolling text which can be used for advertisements.

It will be apparent to a person skilled in the art that microcomputer 104 includes a memory which can be volatile or non-volatile for storing different advertisements or identifiers for reuse and regulation purposes. The microcomputer 104 can be coupled with one or more billboards installed on the outer surface of the vehicle and configure the billboards to display the same advertisement simultaneously.

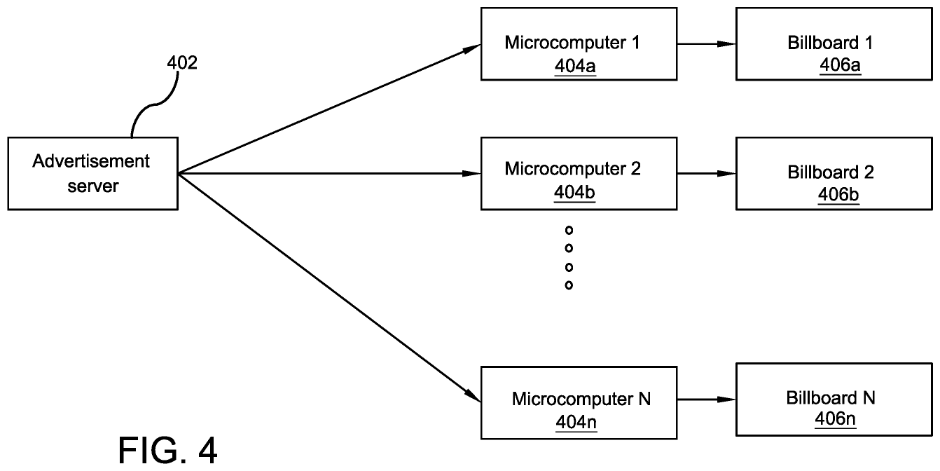

FIG. 4 illustrates a functional block diagram showing another embodiment of the mobile advertising system of the present invention with a central advertisement server for pushing advertisements in accordance with the disclosed architecture. In the present embodiment, an advertisement server 402 is used for creating advertisements and pushing (i.e., sending) the created advertisements to one or more microcomputers 404a-n, wherein each microcomputer is installed in a vehicle as illustrated in FIG. 3.

In one embodiment, the advertisement server 402 can be monitored and operated by a fleet company having multiple vehicles in the fleet. The advertisements can be pushed using satellite communications or any other conventional communication technology used in the state of the art. The microcomputer of each vehicle is coupled to the corresponding one or more billboards 406 of the vehicle as illustrated in FIGS. 1 and 4, for displaying the advertisement for mobile advertising. The microcomputers can be used for configuring advertisements as illustrated in FIG. 3 and can also be used for displaying advertisements pushed by the advertisement server 402.

The advertisement server 402 can be a cloud server or in some embodiments can also be a distributed server, wherein the server 402 pushes the advertisements to microcomputers of the vehicles which are in geofence of the advertisement server 402. The server 402 can also push an emergency situation or information message for display on the billboards for broadcasting of the message.

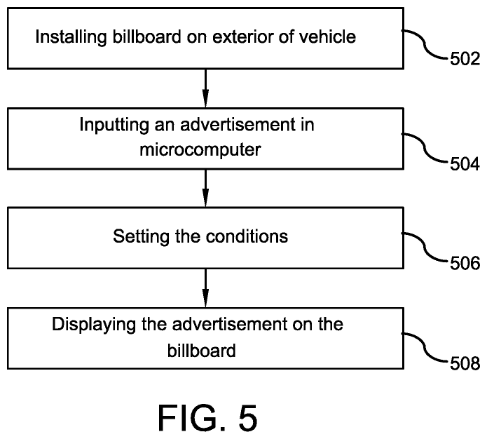

FIG. 5 illustrates flow diagram depicting a process of displaying advertisements on the electronic billboard of the mobile advertising system of the present invention in accordance with one embodiment. Initially, a billboard is integrated or mounted on the exterior surface of a vehicle (Step 502). The billboard is preferably an LED panel and can be flexible. During installation, electrical connectivity with the onboard microcomputer 104 is also established via a wired or wireless connection.

In the next step 504, the microcomputer 104 is accessed using one or more of the provided interfaces (touchscreen, keyboard, or voice command) and one or more advertisements are created or uploaded using the software of the microcomputer 104. In step 506, different conditions such as the times and location under which advertisement is displayed are set using the microcomputer 104. Additional conditions such as automatic brightness adjustment, content rotation, or other dynamic changes based on external factors (like ambient light or weather conditions) can also be set.

Finally, in the step 508, the advertisement is displayed on the billboard 102 allowing the advertisement to be visible clearly from a distance. The display can be in ticker format or can be a conventional rectangular display to support both image and video content.

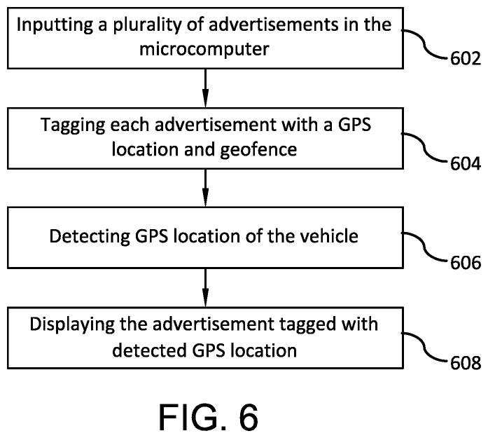

FIG. 6 illustrates another flow diagram depicting display of customized advertisements based on the location of the vehicle in accordance with the disclosed architecture. Initially, one or more advertisements are input or configured in the microcomputer of the system 100 (Step 602). The advertisements can be pushed by the server as illustrated in FIG. 4. Then, in the present embodiment, each advertisement is tagged with a GPS location and a geofence (Step 604). This allows the system 100 to display the advertisement only associated (i.e., tagged) in a specific geofence, thereby providing a targeted and personalized outreach for marketing, identifying, and branding.

For display of the advertisements, the microcomputer 104 detects location of the vehicle in real-time (Step 606) and the advertisement tagged or associated with the geofence and location are displayed in real-time on the billboard 102 (Step 608). When a plurality of advertisements are associated with a location, then, the advertisements are displayed based on preconfigured sequence and time periods.

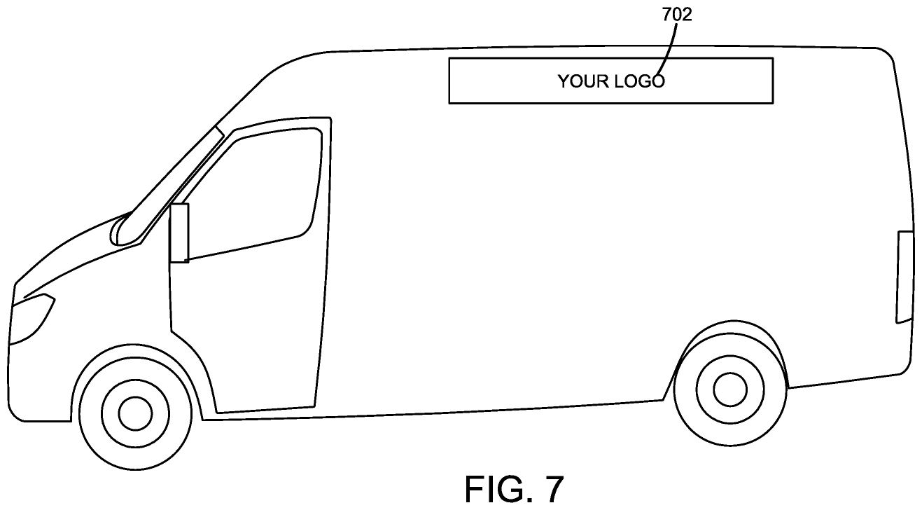

FIG. 7 illustrates another embodiment of the electronic billboard of the present invention in accordance with the disclosed structure. The billboard 702 can be designed considering size, type, and intended vehicle such as commercial van, bus, truck, and more. The billboard 702 is securely mounted on the vehicle and is continuously monitored for any technical issues.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mobile advertising system”, “mobile billboard system”, “vehicle mounted billboard system”, “vehicle mounted digital advertising system”, and “system” are interchangeable and refer to the vehicle mounted advertising billboard system 100 of the present invention.

Notwithstanding the forgoing, the vehicle mounted advertising billboard system 100 of the present invention can be of any suitable size and configuration as is known in the art without affecting the overall concept of the invention, provided that it accomplishes the above stated objectives. One of ordinary skill in the art will appreciate that the vehicle mounted advertising billboard system 100 as shown in the FIGS. is for illustrative purposes only, and that many other sizes and shapes of the vehicle mounted advertising billboard system 100 are well within the scope of the present disclosure. Although the dimensions of the vehicle mounted advertising billboard system 100 are important design parameters for user convenience, the vehicle mounted advertising billboard system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile billboard system for advertising with a vehicle, the mobile billboard system comprising:
a digital billboard for mounting to a vehicle exterior surface;
a vehicle power supply;
a microcomputer;
a processor; and
a connector;
wherein said digital billboard displays selectable advertisements on said vehicle exterior surface;
wherein said vehicle power supply is selected from the group consisting of an internal electrical vehicle supply and an external electrical vehicle supply; and
further wherein said microcomputer having an input for communicating with said processor for creating said selectable advertisement.

2. The mobile billboard system of claim 1, wherein said connector is the vehicle ECU.

3. The mobile billboard system of claim 2, wherein said exterior surface is a side of a tractor's trailer.

4. The mobile billboard system of claim 1, wherein said external electrical vehicle supply is selected from the group consisting of a solar power cell and a battery.

5. The mobile billboard system of claim 4, wherein said advertisements are selected from the group consisting of a text and an image.

6. The mobile billboard system of claim 5, wherein said advertisement displays on said digital billboard in a form selected from the group consisting of a scrolling format, a continuous format, and a flashing format.

7. The mobile billboard system of claim 6, wherein said digital billboard is an LED display.

8. The mobile billboard system of claim 6, wherein said input selected from the group consisting of a touch display, a keyboard, and a microphone.

9. The mobile billboard system of claim 8, wherein said input having a biometric authentication.

10. The mobile billboard system of claim 8, wherein said touch display displays said advertisements.

11. The mobile billboard system of claim 10, wherein said advertisement is a ride share identifier.

12. A mobile billboard system for advertising with a vehicle, the mobile billboard system comprising:
a digital billboard for mounting to a vehicle exterior surface;
a vehicle power supply;
a microcomputer;
a processor;
a connector; and
a central advertisement server;
wherein said digital billboard displays selectable advertisements on said vehicle exterior surface;
wherein said vehicle power supply is selected from the group consisting of an internal electrical vehicle supply and an external electrical vehicle supply; and
further wherein said central advertisement server is a remote centralized server for sending said selectable advertisements to a plurality of said microcomputers.

13. The mobile billboard system of claim 12, wherein said microcomputer having an input for communicating with said processor for creating said selectable advertisement.

14. The mobile billboard system of claim 12, wherein said exterior surface is a side of a tractor's trailer.

15. The mobile billboard system of claim 12, wherein said advertisements are selected from the group consisting of a text and an image.

16. The mobile billboard system of claim 12, wherein said advertisement displays on said digital billboard in a form selected from the group consisting of a scrolling format, a continuous format, and a flashing format.

17. The mobile billboard system of claim 12, wherein said digital billboard is an LED display.

18. The mobile billboard system of claim 13, wherein said input selected from the group consisting of a touch display, a keyboard, and a microphone.

19. The mobile billboard system of claim 18, wherein said touch display displays said advertisements, and further wherein said advertisement is a ride share identifier.

20. A mobile billboard system for advertising with a vehicle, the mobile billboard system comprising:
a digital billboard for mounting to a vehicle exterior surface;
a vehicle power supply;
a microcomputer;
a processor;
a connector; and
a central advertisement server;
wherein said digital billboard displays selectable advertisements on said vehicle exterior surface;
wherein said vehicle power supply is selected from the group consisting of an internal electrical vehicle supply and an external electrical vehicle supply;
wherein said central advertisement server is a remote centralized server for sending said selectable advertisements to a plurality of said microcomputers; and
further wherein said sending said selectable advertisements to a plurality of said microcomputers is within a predetermined geofence area.
